(19) United States
(12) Patent Application Publication
(10) Pub. No.: US 2010/0061737 A1
(43) Pub. Date: Mar. 11, 2010

(54) OPTICAL RECEIVER WITH LOW-PASS FILTER AND MLSE UNIT, AND OPTICAL COMMUNICATION SYSTEM IMPLEMENTING THE OPTICAL RECEIVER

(75) Inventor: Takatoshi Kato, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: SUMITOMO ELECTRIC INDUSTRIES, LTD., Osaka-shi (JP)

(21) Appl. No.: 12/555,113

(22) Filed: Sep. 8, 2009

(30) Foreign Application Priority Data
Sep. 8, 2008 (JP) 2008-229854

(51) Int. Cl. H04B 10/12; H04B 10/06

(52) U.S. Cl. 398/147; 398/208

(57) ABSTRACT

An optical receiver is disclosed in which the error rate for the received data may be effectively reduced even for the non-linear optical transmission system that provides a directly modulate laser diode as the optical transmitter and the single mode fiber inevitably accompanying with the dispersion as the transmission medium. The optical receiver includes a photodiode (PD), a low-pass filter (LPF) and a maximum likelihood sequence estimator (MLSE) carrying out the Viterbi algorithm. The LPF in front of the MLSE effectively suppresses the ringing appeared in the received signal to generate a replica data with good reproducibility.

### BACKGROUND OF THE INVENTION

1. Field of the Invention

The present invention relates to an optical receiver, in particular, the invention relates to an optical receiver that has a function of the maximum likelihood sequence estimation.

2. Related Prior Art

In an optical communication system, an optical signal that is transmitted from an optical transceiver in one side propagates on an optical fiber and is received by another optical transceiver set in the other side. Such an optical communication system using the optical fiber may transmit large capacity of information with relatively high speed. Recently, the optical communication system usually provides, as the optical transmission medium, a single mode fiber and provides installs an optical transmitter that installs a semiconductor laser diode for emitting signal light with a wavelength of 1.55 μm and an external modulator independent of the laser diode. A technique to use the external modulator may narrower the spectrum width of the signal light emitted from the laser diode, which may suppress the dispersion and the degradation of the waveform of the signal light. Such an optical transmitter is widely applied to the system of the SDH (Synchronous Digital Hierarchy), the SONET (Synchronous Optical NETwork) and so on whose transmission speed is 10 Gbps and the transmission distance of 40 km, 80 km or farther.

Technique to correct dispersion electrically has been investigated. Sometimes it is practically applied to the optical system to extend the transmission distance further. Bulow et al. has disclosed in the optical fiber conference held in 2004, titled by “Electron Equalization of Transmission Impariments,” one of those techniques, in which an optical transceiver installs a transversal filter to perform, what is called, the feed forward equalize (FFE) or decision feedback equalizer (DFE). United Stats patent published as US20040264555A or IEEE Journal of Solid State Circuit, vol. 41 (11), pages 2541-2544 in 2004, titled by “An MLSE Receiver for Electronic Dispersion Compensation of OC-192 Fiver Links”, authored by Bae et al, have disclosed another dispersion correction technique called as the maximum likelihood sequence estimation (hereafter denoted as MLSE). Japanese patent published as JP-2006-287694A and JP-2006-287695A have been disclosed an optical transceiver that provides the function of the electronic dispersion correction (hereafter denoted as EDC) preformed by narrowing the transmission band width or the receiver band width to suppress the degradation of the signal waveform due to the dispersion and to compensate the signal loss at higher frequencies.

When the optical transmitter installs an LD directly modulated instead of the external modulator, although it may lower the cost of the transmitter, it inevitably attributes with the chirping, which is the shift of the emission spectrum between the ON state and the OFF state of the LD, which enlarges the spectrum of the transmitter. Propagating the signal light that attributes with the chirping within the single mode fiber, the signal waveform causes a ringing, some overshoot and undershoot influenced by the dispersion of the optical fiber. Conventionally, the EDC technique using the FFE and the DFE described above to compensate the transmission loss in the higher frequency band has brought a remarkable efficacy primarily in the linear transmission. However, in a non-linear transmission such as a case the LD is directly modulated, such EDC techniques were hard to show the improvement. On the other hand, the dispersion correction using the MLSE technique has brought some efficacy in the non-linear transmission compared with the techniques of the FFE and the DEF because the MLSE generated a replica of the received signal. Even the MLSE technique has not applied to further complicated signal such as when the LD is directly modulated same as the FFE and the DFE.

Two Japanese patents mentioned described above has disclosed the optical transceiver applied to the linear transmission system with the chirping parameter of α=0 and α=−0.7, and the technique to moderate the rising edge or the falling edge of the signal by reducing the transmission band or the reception band of the optical transceiver. However, these two Japanese patents have not mentioned the threshold to decide whether the received signal was in the HIGH level or in the LOW level, that is, across-point in of the rising edge or the falling edge. Moreover, the equalizer to compensate the loss in the high frequency region may not recover the input data for a case when the receiver data signal is perfectly crushed because the equalizer amplified not only the received data but the noise components. Thus, the further extension of the transmission distance became out of the requests,

The present invention provides an optical transmitter that may suppress the error rate for the received signal even for the non-linear optical transmission system that includes a directly modulated LD with substantial chirping in the output thereof and a single mode fiber with substantial dispersion.

### SUMMARY OF THE INVENTION

One aspect of the present invention relates to an optical transmitter applicable to the non-linear optical transmission system. The optical receiver of the invention comprises: a semiconductor photodiode (PD) that receives an optical signal from the single mode fiber and converts this optical signal into an electrical signal; a low-pass filter (LPF) that has a cut-off frequency and outputs a filtered signal by receiving the electrical signal from the PD; and a maximum likelihood sequence estimator (MLSE) that generates an estimated signal and a replica signal by processing the filtered data according to the Viterbi algorithm.

The cut-off frequency of the LPF is preferably 0.1 to 1.0 times of a frequency of a clock data contained in the optical signal. The cut-off frequency is further preferably 0.2 to 0.5 times of the clock frequency. Because the LPF suppresses the ringing inevitably contained in the input data due to the chirping of the directly modulated LD and the signal mode fiber, the MLSE may generate a replica data closely following the original data.

Another aspect of the present invention relates to an optical communication system that comprises an optical transmitter, a single mode fiber, and an optical receiver. The optical transmitter includes a directly modulated LD to emit light with substantial chirping. The single mode fiber shows substantial dispersion. The optical receiver includes a PD, an LPF, an MLSE and a clock data recovery (CDR). The PD receives the optical data emitted from the LD and transmitted in the single mode fiber and converts this optical signal into an electrical signal. The LPF attributed with a cut-off frequency filters the converted electrical signal. The MLSE performs, by receiving the filtered data from the LPF, the estimation of the maximum likelihood operating according to the Viterbi algorithm and outputting the estimated data. The CDR recovers the clock data from the estimated data output from the MLSE.

In the present invention, the cut-off frequency of the LPF may be set to 0.1 to 1.0 times, preferably 0.2 to 0.5, of the frequency of the clock data recovered by the CDR. Because the LPF suppresses the ringing inevitably involved in the optical data due to the chirping of the directly modulated LD and the dispersion of the single mode fiber, the MLSE may generate a replica data closely following the original data.

### BRIEF DESCRIPTION OF DRAWINGS

The foregoing and other purposes, aspects and advantages will be better understood from the following detailed description of a preferred embodiment of the invention with reference to the drawings, in which:

FIG. 1 is a block diagram of the optical transceiver that includes the optical receiver according to the present invention;

FIG. 2 is a block diagram of the MLSE unit included in the optical receiver of the present invention;

FIG. 3 is a block diagram of the channel generation unit involved in the MLSE unit shown in FIG. 2;

FIG. 4 shows the waveform of the signal light emitted from the directly modulated LD in the optical transmitter and the shift of the oscillation frequency of the LD;

FIG. 5 is an example of the eye diagram of the received data where the signal is output from the optical transmitter with the waveform shown in FIG. 4 and transmitted, as receiving the effect of the dispersion, through the signal mode fiber with a length is 240 km;

FIG. 6 compares the filtered data with the replica data generated in the MLSE unit, in which the filtered data is output from the LPF with the cut-off frequency of 3.1 GHz;

FIG. 7 compares the filtered data with the replica data, where the LPF has the cut-off frequency of 1.0 GHz;

FIG. 8 shows relations of the error counts in the 128 bit sequence and the normalized square difference with respect to the cut-off frequency of the LPF;

FIG. 9 is a block diagram of the Viterbi unit involved in the MLSE unit of the optical receiver; and

FIG. 10 compares the replica data with the received data that transmits through no LPF.

### BRIEF DESCRIPTION OF PREFERRED EMBODIMENTS

Next, preferred embodiments of the present invention will be described as referring to accompanying drawings. In the description of the drawings, the same numerals or symbols will refer to the same elements without overlapping explanations.

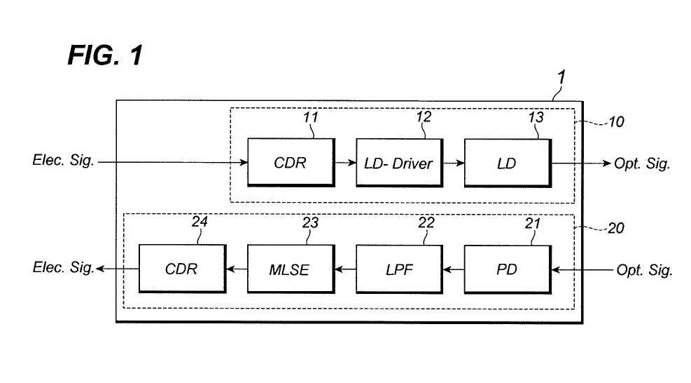

FIG. 1 is a block diagram of an optical transceiver 1 according to an embodiment of the present invention. This optical transceiver 1 provides an optical transmitter 10 and an optical receiver 20. The optical transmitter 10 includes a clock data recovery (hereafter referred as CDR) 11, a laser driver (hereafter denoted as LD driver) 12 and a semiconductor laser diode (hereafter denoted as LD) 13. The CDR 11, receiving an electrical signal to be transmitted, recovers this electrical signal and outputs the recovered electrical signal to the laser driver 12. The LD driver 12, by receiving the recovered electrical signal from the CDR 11, generates a driving signal based on thus received electrical signal to modulate the LD 13 directly. The LD 13, which operates as a converter to convert an electrical signal to an optical signal, by receiving the driving signal from the LD driver 12, converts this driving signal to generate an optical signal with a wavelength of, for instance, 1.55 μm band, which is called as E/O conversion.

The optical receiver 20 includes a photodiode 21, a low-pass filter (hereafter denoted as LPF) 22, an MLSE unit 23 and another CDR 24. The PD 21, by being input the optical signal, converts this optical signal into an electrical signal, which is called as the O/E conversion, corresponding to the optical signal to output thus converted electrical signal to the LPF 22. The PD 21 maybe an avalanche photodiode (APD) that may amplify carriers by the avalanche breakdown mechanism. The LPF 22 passes the signal components below the cut-off frequency fc attributed thereof and may cut the other signal components over the cut-off frequency fc. The LPF 22 may be a type of the Bessel-Thomson filter. The MLSE unit 23 has a function of the dispersion equalizer; that is, the MLSE unit 23 may estimate the received signal by the maximum likelihood sequence for the signal coming from the LPF and may determine the level of the received signal to output thus determined signal to the CDR 24. The CDR 24 may recover the clock and the data from the determined signal provided from the MLSE unit 23.

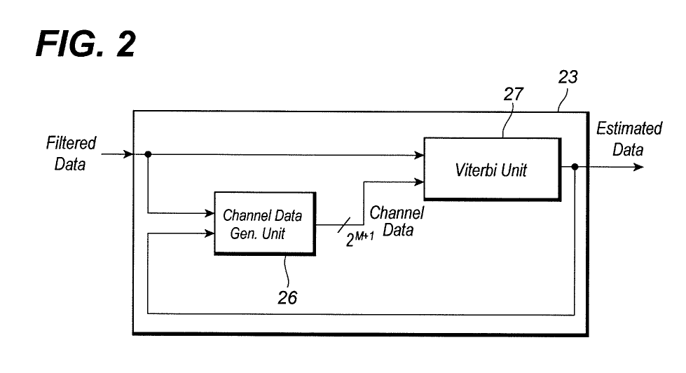

The configuration and the operation of the MLSE unit 23 will be described. FIG. 2 is a block diagram of the MLSE unit 23, in which the MLSE unit 23 includes the channel generation unit 26 and the Viterbi unit 27. The channel generation unit 26, by receiving the signal output from the LPF 22, which is hereinafter called as “filtered data,” and the other signal from the Viterbi unit 27, which is hereinafter called as the “estimated data,” estimates the plurality of channels. The Viterbi unit 27 generates the estimated data by the comparison of the filtered data with the channels according to the Viterbi algorithm.

The Viterbi unit 27 carries out the maximum likelihood sequence estimation according to the Viterbi algorithm between the channels output by the channel generation unit 26 and the filtered data. The Viterbi unit 27 decides one of combinations of the channels so as to minimize the difference between the filtered data and the combined channels. Assuming the channels output from the channel generation unit 26 is four (4), that is, the channel generation unit 26 includes four stages, the number of combinations of the channels becomes 2⁴=16. Thus, the Viterbi unit compares the filtered data with all of 16 combinations of the channels, and decides only one of the combinations which give the minimum square error with respect to the filtered data. It is quite important how the channels are exactly and adequately generated. Although the replica, which is formed by the best combination of the channels, initially includes a large square error to the filtered data, the iteration of the feed forward estimation by the FFE unit 26 and the maximum likelihood estimation by the Viterbi unit 27 may effectively reduce the square error; thus, the estimated data may exactly reflect the transmission data.

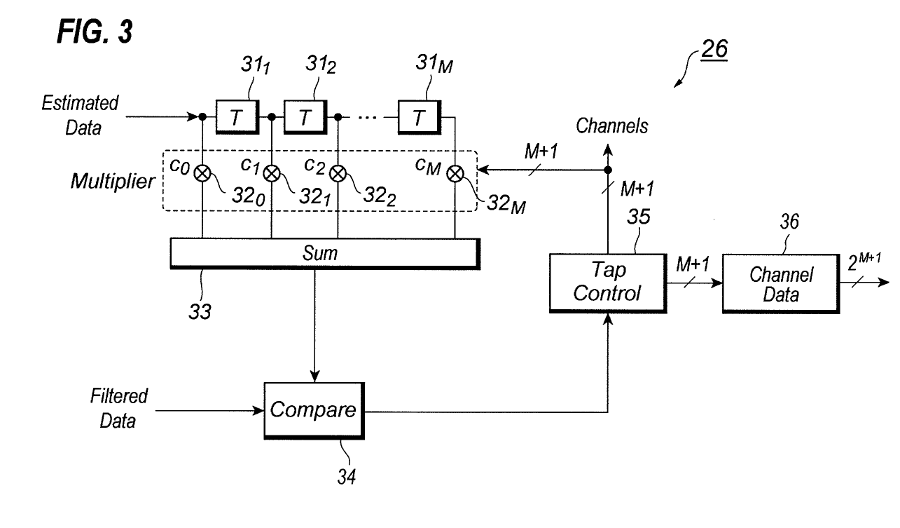

FIG. 3 illustrates a block diagram of the channel generation unit 26. The FFE unit 26 may include, what is called, the transversal filter. The transversal filter comprises the M stages of the delayed unit that are connected in series, M+1 counts of the multipliers, 32₀ to 32_{M}, the sum unit 33, the comparator 34, the tap controller 35 and the channel data generator 36.

Each of the delayed unit, 31₁ to 31_{M}, outputs the estimated data with a unit delay time T. The unit delay time T corresponds to the period of the clock recovered by the CDR 24. Each of the multiplier, 32₀ to 32_{M}, multiplies the output of the delayed unit, 31₁ to 31_{M}, output from the delayed unit by respective tap coefficient, c₀ to c_{M}, and provides thus multiplied data to the sum unit 33. The first multiplier 32₀ multiplies the raw estimated data without any delay with the first tap coefficient c₀. The sum unit 33 sums the output of each of the multiplier, 32₀ to 32_{M}, and provides thus summed data to the comparator 34. The comparator 34 compares the output of the sum unit 33 with the filtered data to generate an error signal. The tap control 35 decides each of the tap coefficients, c₀ to c_{M}, so as to minimize the output of the comparator 34, namely, a difference between the output of the sum unit 33 and the filtered data 35. In other words, the tap coefficients, c₀ to c_{M}, are decided such that the output of the sum unit 33 accurately follows the filtered data. The tap coefficients, c₀ to c_{M}, thus decided are provided to the Viterbi unit 27 to carry the MLSE algorithm thereat. The channel data generator 36 generates, by receiving the set of tap coefficients, c₀ to c_{M}, a set of channel data. That is, assuming the stage M of the FFE is equal to 3, that is, the transversal filter includes three delayed unit 31₁ to 31₃, four (4) tap coefficients are decided in the tap control 35 and 2⁴=16 numbers of the combinations listed below are generated in the channel data generator 36:

TABLE I
Algorithm to generate channel data

Logical
Combination of:

| | c₃ | c₂ | c₁ | c₀ | Channel data |
|---|---|---|---|---|---|
| r₀ | 0 | 0 | 0 | 0 | 0 |
| r₁ | 0 | 0 | 0 | 1 | c₀ |
| r₂ | 0 | 0 | 1 | 0 | c₁ |
| r₃ | 0 | 0 | 1 | 1 | c₀ + c₁ |
| r₄ | 0 | 1 | 0 | 0 | c₂ |
| r₅ | 0 | 1 | 0 | 1 | c₂ + c₀ |
| r₆ | 0 | 1 | 1 | 0 | c₂ + c₁ |
| r₇ | 0 | 1 | 1 | 1 | c₂ + c₁ + c₀ |
| r₈ | 1 | 0 | 0 | 0 | c₃ |
| r₉ | 1 | 0 | 0 | 1 | c₃ + c₀ |
| r₁₀ | 1 | 0 | 1 | 0 | c₃ + c₁ |
| r₁₁ | 1 | 0 | 1 | 1 | c₃ + c₁ + c₀ |
| r₁₂ | 1 | 1 | 0 | 0 | c₃ + c₂ |
| r₁₃ | 1 | 1 | 0 | 1 | c₃ + c₂ + c₀ |
| r₁₄ | 1 | 1 | 1 | 0 | c₃ + c₂ + c₁ |
| r₁₅ | 1 | 1 | 1 | 1 | c₃ + c₂ + c₁ + c₀ |

These 16 channel data are provided to the Viterbi unit 23 and carried out for the maximum likelihood estimation.

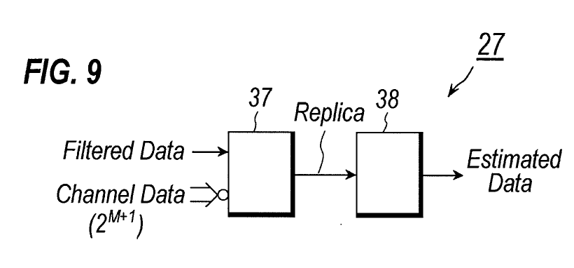

Next, the operation of the Viterbi unit 27 will be described. FIG. 9 illustrates a block diagram of the Viterbi unit 27 that includes the ML operator 37 and the logic converter 38. The ML operator 37 selects, comparing the filtered data from the LPF 22 with the one of the channel data provided from the channel data generator 36 in the channel generation unit 26. Referring to the model case listed in Table I, the ML operator 37 may select r₁₁=c₃+c₁+c₀, which is one of combinations of the channel data, after the calculation of (r_{N}−d)², where N=0 to 15 and d is the magnitude of the filtered data at the event under examination, and the decision that the combination r₁₁ gives the minimum square difference. The ML operator 37 sequentially performs the operation described above and continuously provides the selected combination as the replica data.

The logic converter selects one of the logical levels of the replica data. That is, refereeing to Table I again, when the ML operator 37 selects the combination r₁₁, the logic convert 38 sets the logic level of “1” for the tap coefficient c0 at the present event. As described above, when the ML operator 37 selects the combination r₈ for the next event, the logic converter 38 sets the logic level of “0” because the tap coefficient c₀ of the combination r₈ is given by “0”. Thus, the logic converter 38 sequentially outputs the logic level corresponding to the tap coefficient of c₀ as the estimated data. The estimated data thus determined and having the logic level is fed back to the channel generation unit to determine the tap coefficients for the subsequent events.

According to the optical transceiver 1 of the present invention, even the optical transmitter emits signal light with substantial chirping by directly modulating the LD and the signal light received at the receiver or the electrical signal converted from the received light imply the ringing due to a multiplicative effect of the dispersion of the transmission medium and the chirping of the original light; the LPF 22 installed in front of the MLSE unit 23 may suppress the ringing. Moreover, because the MLSE unit 23 may determine the channels by the channel generation unit 26 based on the filtered signal, the square error between the filtered signal and the replica signal best combined with the channels may be reduced.

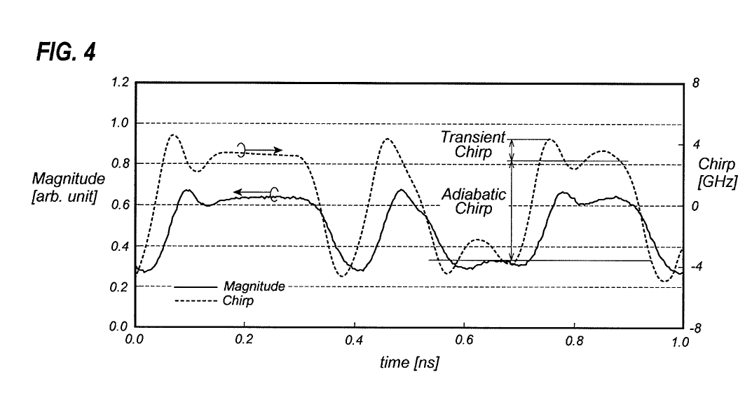

Next, an example of the optical communication will be described applying the optical transceiver that includes the optical receiver of the present invention. FIG. 4 illustrates a typical example of the waveform and the chirping of the signal light emitted from the optical transmitter, in which the LD that emits light of the 1.55 μm band is directly modulated at 10.3125 Gbps. As shown in FIG. 4, the directly modulated LD inevitably shows the chirping, that is, the oscillation frequency shifts by about 6 GHz between the level “0” and that of the “1”. This shift in the oscillation frequency is called as the adiabatic chirping; while, FIG. 4 shows another shift in the frequency at the rising of the signal, which is called as the transition chirping of about 2 GHz.

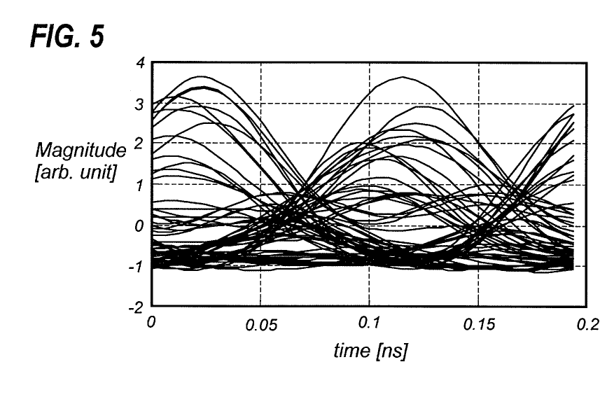

FIG. 5 shows an example of the eye diagram of the electrical signal when the optical signal shown in FIG. 4 is transmitted in the signal mode fiber whose length is 240 km and received by the PD 21 with a frequency bandwidth of 7.7 GHz to convert the optical signal to the electrical signal. FIG. 5 shows substantially no eye opening. This is because the signal light shown in FIG. 4 inevitably accompanies with the positive adiabatic chirping and the transition chirping for the level “1” and the signal corresponding to the level “1” propagates within the signal mode fiber with the positive dispersion faster than the signal corresponding to level “0”. Thus, the received signal causes a complex degradation including a large ringing after the transmission due to the mutual effect of the dispersion of the single mode fiber and the chirping of the directly modulated LD.

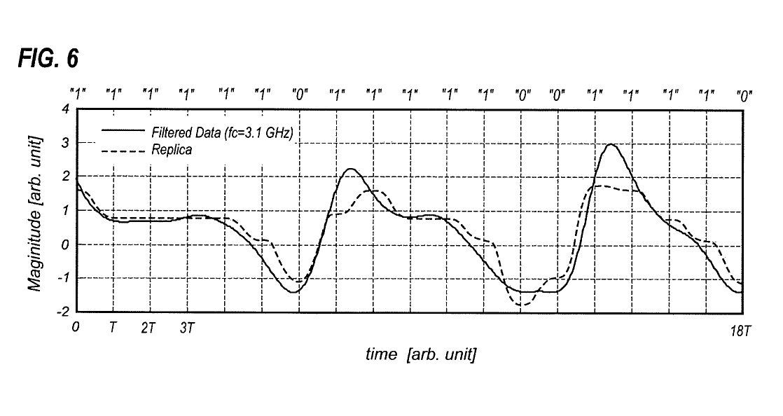

FIG. 6 shows the filtered data, which is the output of the LPF 22 with the cut-off frequency of 3.1 GHz, and the replica generated by the ML operator in the MLSE unit 23 corresponding to the filtered data. In the present example, the channel generation unit 26 comprises the transversal filter with four stages of the multiplier, that is, the transversal filter in the channel generation unit 26 includes three (3) delayed units. In FIG. 6, one division in the horizontal axis corresponds to a moment whether the filtered data or the replica data is in the level “0” or in the level “1”. As shown in FIG. 6, the filtered data reduces the ringing involved in the received data by the LPF 22 and no large difference is recognized between the filtered data and the replica data.

Moreover, calculating the square difference between the filtered data and the replica data for the test signal generated by the pseudo random bit stream (PRBS) with seven (7) stages, which is equivalent to 128 bit random sequence, the result becomes −8.0 dB for the square difference, which is normalized by the magnitude of ±1, and the error count of zero (0). Thus, the optical receiver of the present invention may suppress the error rate even for the extremely degraded data in the non-linear optical communication system using the directly modulated LD in the optical transmitter and the single mode fiber with the dispersion.

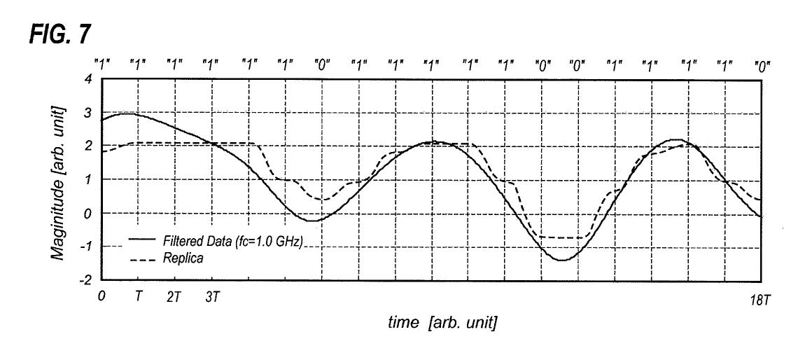

Another example is illustrated in FIG. 7, in which the data provided to the MLSE unit 23 is filtered by the LPF 22 with the cut-off frequency of 1.0 GHz. The channel generation unit 26 comprises four stages of the transversal filter as that of the example described above. The LPF 22 in this example may reduce the ringing, which results in the normalized square difference of −9.0 dB. However, the LPF 22 excessively cuts the information intrinsically involved in the received data, which increases the number of errors within the 128 bit sequence to 14 errors, which is equal to the error rate of 0.1.

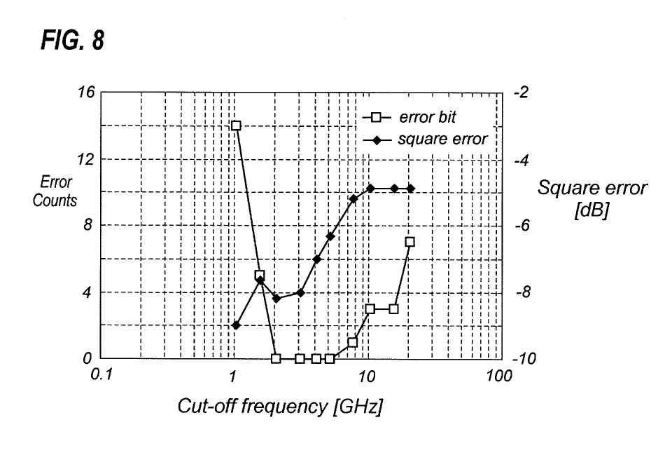

FIG. 8 shows a relation of the error counts in the 128 bit sequence and the normalized square error to the cut-off frequency of the LPF 22. Both the error counts and the normalized square difference may be reduced by the LPF 22 because the LPF 22 may suppress the ringing; but excessively reduced cut-off frequency increases the error counts because the filtered data provided from the LPF 22 lacks the information intrinsically involved in the original data.

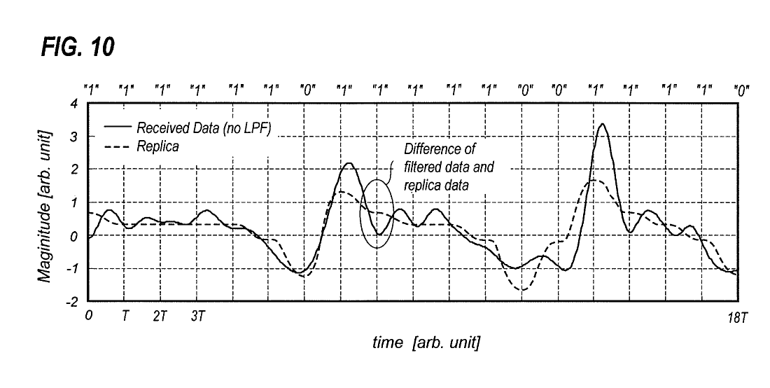

FIG. 10 shows a result for the conventional optical receiver without any LPF in front of the MLSE unit. Other arrangements of the optical receiver, those of the optical transmitter and the data to be transmitted are same as those of the present invention. The replica signal is, as shown in FIG. 10, often alienated from the received data directly provided from the PD affected by the large ringing. In such a case, the normalized square difference and the error counts within 128 bit sequence became −4.9 dB and seven (7), equal to the error rate of 5×10⁻², respectively. The large ringing may result in an erroneous replica data.

The optical receiver 20 of the present invention may achieve the square error below −5 dB and the error counts below 5 in the 128 bit sequence, which is equal to the error rate below 4×10⁻², as shown in FIG. 8 when the cut-off frequency of the LPF 22 is set from 0.15 to 1.0, which is equal to the frequency of 1.5 to 10 GHz, times of the signal frequency of 10.3125 GHz. Moreover, the cut-off frequency from 2 to 5 GHz, which corresponds to 0.2 to 0.5 times of the signal frequency of 10.3125 GHz, may show the square error below −6 dB and the zero error counts in 128 bit sequence.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. For instance, the embodiment described above decides the tap coefficients of the channel generation unit 26 and generates the replica signal based on the estimated data provided from the Viterbi unit 27 and the filtered data. However, the Viterbi unit 27 may generate the replica signal from a preset sequence instead of the estimated data, which is called as the training mode. Therefore, it is intended that the present invention not be limited to the particular embodiments disclosed, but that the invention include all embodiments falling within the scope of the appended claims.

I claim:

1. An optical receiver coupled with a single mode fiber with dispersion, said single mode fiber being coupled with an optical transmitter that includes a directly modulated semiconductor laser diode (LD) as a light source, said optical receiver comprising:
a semiconductor photodiode (PD) configured to receive an optical signal from said single mode fiber and to convert said optical signal into an electrical signal;
a low-pass filter (LPF) attributed with a cut-off frequency, said low-pass filter receiving said electrical signal and outputting a filtered signal; and
a maximum likelihood sequence estimator (MLSE) configured to generate an estimated signal based on said filtered signal.

2. The optical receiver of claim 1,
wherein said optical signal provided from said single mode fiber involves a clock data and said cut-off frequency of said LPF is 0.15 to 1.0 times of a frequency of said clock data.

3. The optical receiver of claim 2,
wherein said cut-off frequency of said LPF is 0.2 to 0.5 times said frequency of said clock data.

4. The optical receiver of claim 1,
wherein said MLSE unit includes a channel generation unit and a Viterbi unit, said channel generation unit including a transversal filter with M-stages and a channel data generator, said channel generation unit adjusting tap coefficients of said transversal filter so as to minimize a difference between said filtered signal and an output of said Viterbi unit, said channel data generator generating 2^{M+}1 sets of channel data derived from said tap coefficients, and
wherein said Viterbi unit compares said filtered signal with each of said channel data and selects one of said channel data most close to said filtered signal.

5. The optical receiver of claim 4,
wherein said Viterbi unit includes a maximum likelihood (ML) operator and a logic converter, said ML operator selecting one of said channel data according to Viterbi algorithm, said logic converter setting a logic level corresponding to one of tap coefficients and outputting said logic level as an estimated data to said channel generation unit.

6. An optical communication system, comprising:
an optical transmitter that includes a semiconductor laser diode (LD) directly modulated by an LD driver, said LD emitting light with substantial chirping;
a single mode optical fiber as a medium to transmit said light emitted from said optical transmitter, said single mode fiber showing substantial dispersion; and
an optical receiver including a semiconductor photodiode (PD), a low-pass filter (LPF) attributed with a cut-off frequency, a maximum likelihood sequential estimator (MLSE) and a clock data recovery (CDR), said PD receiving said signal light transmitted from said single mode fiber and converting said signal light into an electrical signal, said LPF receiving said electrical signal and outputting a filtered data, said MLSE receiving said filtered data and generating an estimated data most likelihood of said filtered data, said CDR recovering a clock data contained in said estimated data.

7. The optical communication system of claim 6,
wherein said cut-off frequency of said LPF in said optical receiver is 0.15 to 1.0 multiplied by a frequency of said clock data.

8. The optical communication system of claim 7,
wherein said cut-off frequency of said LPF is 0.2 to 0.5 multiplied by said frequency of said clock data.

9. The optical receiver of claim 6,
wherein said MLSE unit includes a channel generation unit and a Viterbi unit, said channel generation unit including a transversal filter with M-stages and a channel data generator, said channel generation unit adjusting tap coefficients of said transversal filter so as to minimize a difference between said filtered data and an output of said Viterbi unit, said channel data generator generating 2^{M+}1 sets of channel data derived from said tap coefficients, and
wherein said Viterbi unit compares said filtered data with each of said channel data and selects one of said channel data that is most close to said filtered data.

10. The optical receiver of claim 9,
wherein said Viterbi unit includes a maximum likelihood (ML) operator and a logic converter, said ML operator selecting one of said channel data according to Viterbi algorithm, said logic converter setting a logic level corresponding to one of tap coefficients and outputting said logic level as an estimated data to said channel generation unit and said CDR.
